(19) United States
(12) Patent Application Publication
(10) Pub. No.: US 2026/0350577 A1
(43) Pub. Date: Nov. 5, 2026

(54) SUGGESTED UPDATES OF RECURRING DEVICE TRANSACTIONS

(71) Applicant: Motorola Mobility LLC, Chicago, IL (US)

(72) Inventors: Amit Kumar Agrawal, Bangalore (IN); Nakul Patel, Bangalore (IN); Krishnan Raghavan, Bangalore (IN)

(73) Assignee: Motorola Mobility LLC, Chicago, IL (US)

(21) Appl. No.: 19/195,530

(22) Filed: Apr. 30, 2025

(51) Int. Cl. G06Q 20/22; G06Q 20/38; G06Q 40/02

(52) U.S. Cl. CPC G06Q 20/229; G06Q 20/382; G06Q 40/02

(57) ABSTRACT

In aspects of suggested updates of recurring device transactions, a computing device collects transaction data, identifies one or more recurring transactions based on the transaction data, and determines whether a transaction parameter of a future recurring transaction from the one or more recurring transactions is changed. The computing device, responsive to a determination of a change in the transaction parameter, associates the future recurring transaction with an automatic payment, outputs an alert indicating the change and requesting user consent to update the transaction parameter, and updates the transaction parameter prior to executing the future recurring transaction.

### BACKGROUND

Transaction management services facilitate various recurring transactions for computing device users, including financial transactions (e.g., bill payments, subscription fees, automated transfers) and non-financial transactions (e.g., data backups, software updates, periodic information). Automation improves efficiency with these services. However, when recurring transaction details change, the changes are often communicated outside the services themselves, through external communication channels, such as text messages, emails, notifications, and social media. Failure to update payment amounts or otherwise account for a change may result in underpayments, service disruptions, and other inconveniences.

### BRIEF DESCRIPTION OF THE DRAWINGS

Implementations of techniques for suggested updates of recurring device transactions are described with reference to the following Figures. The same numbers may be used throughout to reference like features and components shown in the Figures.

FIG. 1 illustrates an example environment for executing suggested updates of recurring device transactions on a computing device in accordance with one or more implementations as described herein.

FIG. 2 illustrates an example system that performs suggested updates of recurring device transactions, in accordance with one or more implementations as described herein.

FIG. 3 illustrates an example scenario involving application notifications processed into suggested updates of recurring device transactions, in accordance with one or more implementations as described herein.

FIG. 4 illustrates an example scenario involving direct messages processed into suggested updates of recurring device transactions, in accordance with one or more implementations as described herein.

FIG. 5 illustrates an example scenario involving emails processed into suggested updates of recurring device transactions, in accordance with one or more implementations as described herein.

FIG. 6 is a flowchart illustrating an example process for executing suggested updates of recurring device transactions, in accordance with one or more implementations as described herein.

FIG. 7 is a flowchart illustrating another example process for executing suggested updates of recurring device transactions, in accordance with one or more implementations as described herein.

FIG. 8 is a flowchart illustrating another example process for executing suggested updates of recurring device transactions, in accordance with one or more implementations as described herein.

FIG. 9 is a flowchart illustrating another example process for executing suggested updates of recurring device transactions, in accordance with one or more implementations as described herein.

FIG. 10 illustrates various components of an example device that may be used to implement the techniques for s suggested updates of recurring device transactions in accordance with one or more implementations as described herein.

### DETAILED DESCRIPTION

Techniques for suggested updates of recurring device transactions may be implemented as described herein. A computing device, such as any type of mobile or non-mobile device, may be configured to perform the techniques for suggested updates of recurring device transactions.

Transaction management services leverage automation to improve efficiency, reduce manual intervention and enhance user convenience. However, when recurring transaction details change, the changes are often communicated outside the services themselves, through external communication channels. Failure to update payment amounts or otherwise account for a change may result in underpayments, service disruptions, and other inconveniences. The system described herein addresses these challenges by automatically detecting and managing changes in recurring transaction parameters without relying on additional sensors or extensive manual user intervention, thereby improving the reliability and functionality of transaction management across various scenarios.

In aspects of suggested updates of recurring device transactions, a computing device implements a recurring transaction manager that includes a collection module and a change detection engine. In one or more implementations, the recurring transaction manager is housed in a mobile phone, a laptop computer, a tablet device, a central computing device, or a network-based cloud accessible to a computing device. The collection module gathers transaction data from multiple communication channels, including external sources such as text messages, emails, notifications, and social media. The change detection engine identifies recurring transactions, monitors for changes, and detects modifications in transaction parameters. This system facilitates management of various recurring transactions for users, encompassing both financial transactions (e.g., bill payments, subscription fees, automated transfers) and non-financial transactions (e.g., data backups, software updates, periodic information exchanges).

In some examples, by leveraging AI and machine learning algorithms during the collecting, monitoring, and/or change detections, the system analyzes user communications, extracts relevant information, and automatically updates transaction settings. When a change is detected, the recurring transaction manager generates a transaction update and presents an alert to the user via a user interface, allowing for user confirmation before applying the update. This approach addresses the limitations of conventional systems that often rely on manual updates or lack dynamic detection capabilities across various types of digital interactions, which can lead to missed updates, user frustration, and potential financial penalties. This feature ensures user consent is obtained prior to changing a transaction.

The techniques discussed herein support a wide range of recurring digital interactions beyond financial transactions. By capturing and processing transaction-related information in a flexible format, the computing device can perform adaptive management of various recurring tasks, including data synchronization, automated reminders, and periodic information updates. This capability enhances the device's ability to adapt to changing user preferences and transaction requirements across diverse usage contexts, improving overall efficiency and user experience while reducing the risk of errors or missed updates.

Accordingly, techniques described herein enable automated generation and processing of recurring transactions. In implementations, a payment transaction represents a transaction. For instance, digital payment transactions involve generating, transmitting, and processing various types of data and across a variety of different systems and networks. Thus, such digital payment transactions can be characterized as sets of computational operations much like other operations of a computing device and/or set of computing devices. Accordingly, by enabling automated generation of transactions of data, including financial transactions of financial or payment data, the described techniques can conserve system resources (e.g., memory, processor bandwidth, network bandwidth, etc.) that may otherwise be used to manually manage recurring transactions, and thus the described techniques can improve the operation of computing devices and data networks. Further, user burden can be reduced by performing suggested updates of recurring device transactions automatically while reducing user interaction to initiate and manage the updates.

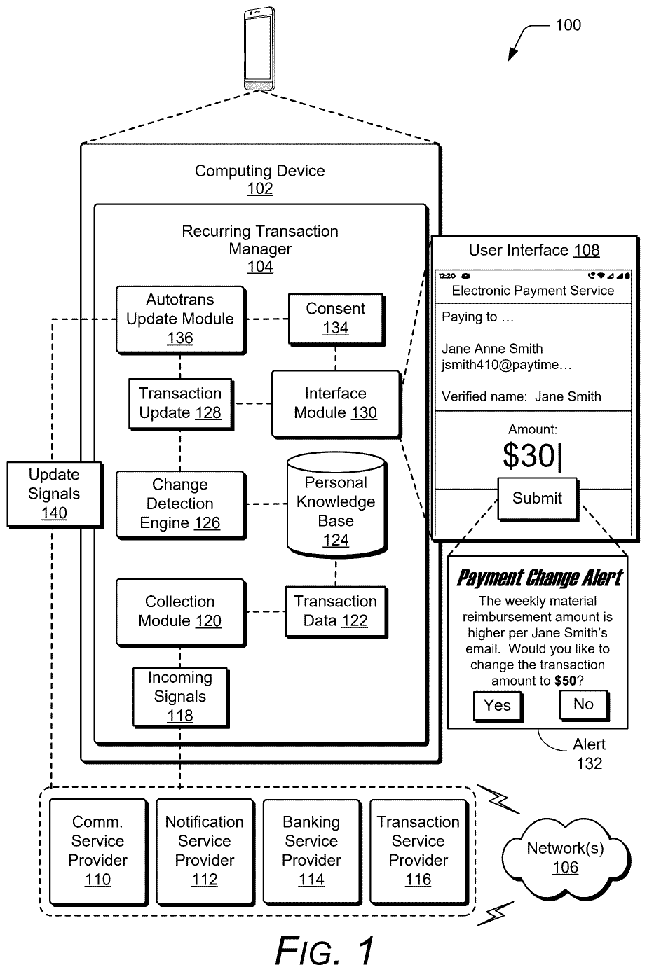

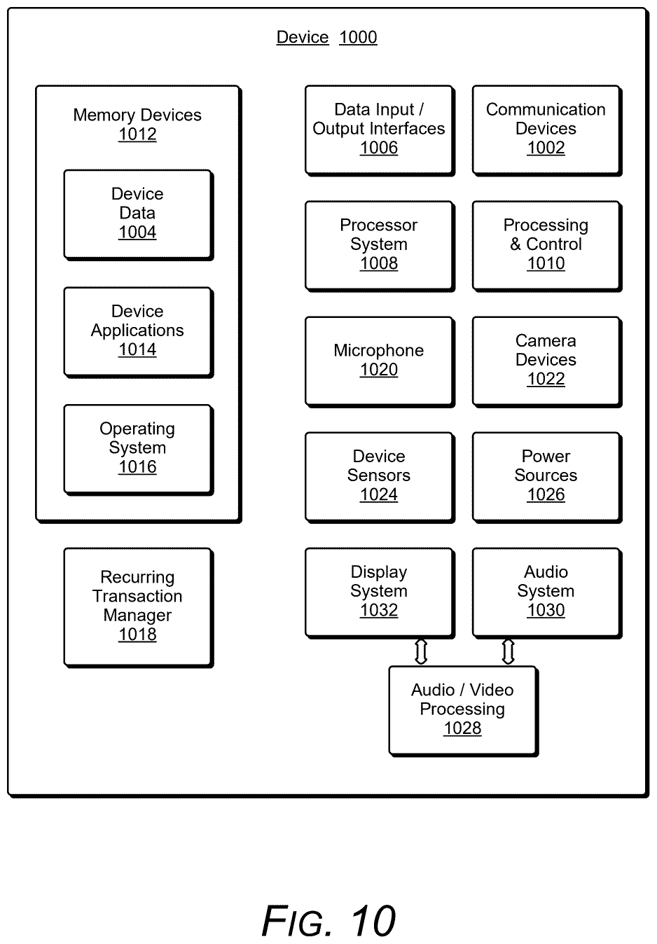

FIG. 1 illustrates an example environment 100 for executing suggested updates of recurring device transactions on a computing device 102, in accordance with implementations of transaction parameter management. The environment 100 includes a computing device 102, which may be a smartphone, tablet, laptop, server, desktop, workstation, terminal, or other conceivable computing device or computing system configurable to connect to a network 106. The computing device 102 incorporates physical components such as a processor, memory, display screen for visual output, speakers for audio output, and input mechanisms (e.g., touchscreen, physical buttons, microphone for voice commands) that enable user interaction. A computing device 1000 is illustrated in FIG. 10 as an example of the computing device 102.

Illustrated in FIG. 1, the computing device 102 houses a recurring transaction manager 104 that oversees aspects of recurring transactions. This recurring transaction manager 104 may be implemented as software instructions stored in memory and executed by the processor, as firmware embedded in the device, as dedicated hardware components (e.g., application-specific integrated circuits), or as a combination of these approaches. This recurring transaction manager 104 communicates with applications and an operating system or platform of the computing device 102 to support presentation of information to a user. This includes supporting presentation of a user interface 108.

The user interface 108 serves as the primary interface through which a user interacts with the computing device 102 to manage various recurring transactions, including financial and non-financial transactions. This interface 108 may be rendered on the display screen as graphical elements with which the user can interact through touch, voice, or other input methods. The user interface 108 supports multiple interaction modalities to accommodate diverse user preferences, including visual displays with high-contrast options, audio interfaces that provide spoken feedback and accept voice commands, audiovisual combinations, haptic feedback systems that use vibration patterns to convey information, and augmented reality overlays that can present transaction data within the user's physical environment. For users with disabilities, the interface 108 incorporates accessibility features such as screen reader compatibility for visually impaired users, closed captioning and visual alerts for hearing-impaired users, simplified interaction patterns for users with cognitive impairments, and switch control compatibility for users with motor limitations. These adaptive interface options ensure that transaction management capabilities remain accessible through the user interface 108, across a spectrum of user abilities and contexts, from traditional office environments to mobile scenarios, allowing users to effectively monitor and respond to transaction parameter changes regardless of their specific accessibility requirements.

The environment 100 includes various service providers connected through the network 106, including a communication service provider 110, a notification service provider 112, a banking service provider 114, and a transaction service provider 116. The network 106 comprises a combination of communication technologies such as cellular networks (e.g., 4G, 5G), Wi-Fi connections, broadband internet infrastructure, fiber optic cables, and satellite communications, which collaborate to facilitate data exchange between the computing device 102 and external services. These providers transmit incoming signals 118 (e.g., communications) containing relevant transaction information through their respective communication channels. For example, the communication service provider 110 might be a cellular carrier that transmits text-based messages about bill payments, while the notification service provider 112 may be a push notification service that delivers application and system notifications.

A collection module 120 within the recurring transaction manager 104 collects, e.g., periodically, or continuously, transaction data 122 from these multiple sources. This module 120 may be implemented as a software component with dedicated application programming interface (API) access for each service provider, enabling the collection module 120 to interface with different data formats and protocols. The transaction data 122 is then added to the personal knowledge base 124 stored on or accessible (e.g., via the network 106) to the computing device 102. The personal knowledge base 124 serves as a repository of transaction-related information, potentially implemented as a structured database, quarriable using keywords or other search parameters, and optionally with encryption capabilities to protect sensitive financial information. The collection module 120 may include a learning model and perform machine learning techniques in some examples. Machine learning components may be implemented using on-device inference capabilities to protect privacy while still providing sophisticated analysis. The collection module 120 processes various types of communications received from multiple sources, including device messages, application notifications, voice messages, video messages, text messages, and emails. The collection module 120 extracts the transaction data 122 by parsing these communications for transaction-related information, such as payment amounts, due dates, service providers, and account identifiers. Additionally, the collection module 120 aggregates the transaction data 122 by constructing a personal knowledge base 124 of historical transaction profiles representing patterns and relationships within the transaction data. This comprehensive approach enables the system to maintain awareness of recurring transactions across diverse communication channels.

The change detection engine 126 is another component of the recurring transaction manager 104, which monitors the personal knowledge base 124 for modifications in recurring transactions. This change detection engine 126 may be implemented as a software module utilizing statistical analysis algorithms and pattern recognition techniques to identify changes in transaction parameters. When a change is detected in a transaction parameter, such as an increase in a monthly art class material fee or a modification to a payment schedule, the recurring transaction manager 104 generates a transaction update 128 including relevant information about the change. The transaction update 128 may be structured as a data object with fields for the transaction identifier, previous parameter value, new parameter value, effective date, and source of the change information. The change detection engine 126 may include a learning model and perform machine learning techniques in some examples. As mentioned above, machine learning components can use on-device inference capabilities of the computing device 102 to protect privacy.

The interface module 130 outputs this information through the user interface 108, displaying an alert 132 about the transaction parameter change and requesting consent 134 from the user to update the recurring transaction parameter. The interface module 130 may be implemented as a software component that translates data objects into visual elements following the device's design language and accessibility guidelines. The alert 132 can include contextual information such as when the change will take effect and historical data about previous price adjustments for the service.

If a user Sarah provides consent 134 through an interaction with the user interface 108 (such as tapping a confirmation button, providing voice confirmation, or using biometric authentication), the autotrans update module 136 processes the accepted change and generates update signals 140. The autotrans update module 136 may be implemented as a software component with secure communication capabilities to interact with external financial systems. These update signals 140 are then sent through the network 106 to the relevant service providers, ensuring future recurring transactions reflect the updated transaction parameter. For instance, when Sarah's art class material fee increases from $30 to $50, the update signals 140 communicate this change to the peer-to-peer payment service through the transaction service provider 116 to ensure the correct amount is authorized for the current and future transactions. These update signals 140 may be formatted according to specific API requirements for each provider, such as using an industry specific authentication for banking services or proprietary protocols for payment processors.

The collection module 120 processes the incoming signals 118 to extract relevant transaction information. For instance, the module 120 captures information from Jane Smith's email about the upcoming change in the art class material fee. This functionality may integrate advanced natural language processing techniques to extract searchable information from diverse text sources. The collection module 120 may employ techniques such as named entity recognition to identify monetary amounts, dates, and service names within unstructured text, similar to how a free online email provider automatically identifies flight information or package tracking details within emails. By implementing the extraction capabilities of the collection module 120, the recurring transaction manager 104 can process information from various formats without imparting adherence on external providers to a standardized data structure.

The personal knowledge base 124 is regularly updated with new transaction data 122 to maintain a comprehensive record of recurring transactions and their parameters. This approach is analogous to how modern AI assistants maintain and update user profiles to provide personalized responses. The knowledge base 124 may be implemented as a relational database with tables for transactions, payees, payment methods, and historical changes, or as a database optimized for flexible schema and quick retrieval of transaction histories. The personal knowledge base 124 may employ data synchronization protocols to improve consistency across local storage and cloud backups, providing resilience against data loss while maintaining appropriate security measures for financial information.

The change detection engine 126 in variations uses one or more machine learning models to identify patterns and determine whether a transaction parameter of a future recurring transaction has changed. These learning models may be implemented using frameworks such as TensorFlow or PyTorch, and may include supervised learning algorithms trained on historical transaction data to recognize significant variations. For example, the engine 126 detects when Sarah's recurring art class material fee changes from $30 to $50, similar to how advanced fraud detection systems in banking identify unusual transaction patterns. The engine 126 is operable in implementations to employ anomaly detection techniques to distinguish between normal fluctuations (such as variable utility bills that change seasonally) and actual changes to fixed recurring amounts (such as an art class material fee increase). This capability enables the change detection engine 126 to reduce false positives towards zero, while retaining capability to capture genuine parameter changes that support generation of alerts.

When the interface module 130 displays an alert 132, the alert explains the change in Sarah's art class material fee and requests consent 134 from Sarah to update the recurring transaction parameter. The alert 132 may appear as a modal dialog, a notification banner, or another appropriate UI element based on the device's operating system and the urgency of the update. The interface module 130 may implement adaptive timing algorithms to present alerts at opportune moments when users are likely to be receptive, rather than interrupting tasks. Additionally, the module 130 can incorporate accessibility features such as screen reader compatibility and high-contrast options to ensure each user can perceive and respond to the alert 132.

The collection module 120 continuously, or seemingly continuously, monitors communications from various service providers through the network 106, addressing a common pain point where users may otherwise miss notifications about price increases or schedule changes, potentially resulting in insufficient funds, missed payments, or unwanted service interruptions. The computing device 102 may implement background synchronization processes during periods of low device usage to minimize impact on battery life and performance while ensuring transaction data remains current.

The system operates by continuously monitoring communications from various service providers through the network 106. The recurring transaction manager 104 collects transaction data 122 via the collection module 120, storing this information in the personal knowledge base 124. When the change detection engine 126 identifies a modification in a transaction parameter, such as Sarah's art class material fee increasing from $30 to $50, the engine triggers the generation of a transaction update 128. The interface module 130 then presents an alert 132 to Sarah through the user interface 108, seeking consent 134 for the proposed change. This alert might include contextual information such as when the change will take effect and historical data about previous price adjustments for this service. Upon receiving Sarah's approval through an explicit action like tapping a “Confirm” button, the autotrans update module 136 creates update signals 140 that are transmitted back through the network 106 to implement the changes with the relevant service providers. These signals may be formatted according to specific API requirements for each provider, such as using OAuth authentication for banking services or proprietary protocols for payment processors.

This process, from detecting the change in the transaction parameter to updating the future recurring transaction, occurs efficiently, often without requiring extensive user intervention. For example, when Sarah's art class material fee increases from $30 to $50, the system detects this change from Jane Smith's email notification, presents a simple alert showing both the old and new amounts, and upon Sarah's confirmation, updates the peer-to-peer payment settings accordingly. The recurring transaction manager 104 continues to monitor and manage recurring transactions, prepared to output alerts 132 to Sarah regarding future changes and maintain up-to-date transaction parameters. The system may also implement background synchronization processes that operate during periods of low device usage to minimize impact on battery life and performance while ensuring transaction data remains current.

Through this implementation, the computing device 102 collects transaction data 122, identifies recurring transactions, determines whether transaction parameters of future recurring transactions have changed, outputs alerts 132 requesting user consent 134, and updates transaction parameters prior to executing future recurring transactions, while utilizing machine learning models to enhance accuracy and efficiency. These machine learning components may be implemented using on-device inference capabilities to protect privacy while still providing sophisticated analysis. This system may save time, reduce potential issues from missed updates, and provide users with improved control over recurring financial and non-financial transactions, similar to how advanced personal finance management apps like Mint or YNAB help users maintain control over their spending and budgeting. By automating the detection and management of transaction parameter changes, the system addresses a common pain point where users might otherwise miss notifications about price increases or schedule changes, potentially resulting in insufficient funds, missed payments, or unwanted service interruptions.

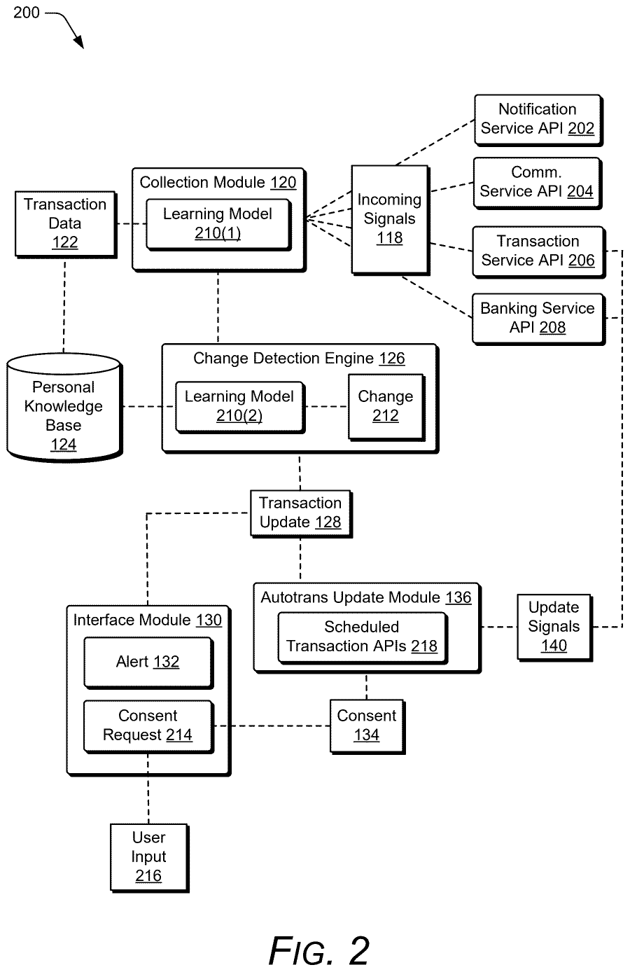

FIG. 2 illustrates an example system 200 that performs suggested updates of recurring device transactions, in accordance with one or more implementations as described herein. The system 200 represents a detailed example of the recurring transaction manager 104 introduced in FIG. 1, conveying with greater detail the internal components and interactions for managing and updating recurring transactions. The flow of data between components is represented by dashed lines in FIG. 2, illustrating the interconnected nature of the system's operations.

The collection module 120 serves as the entry point for transaction-related data. This module 120 incorporates a first learning model 210(1), which may be implemented using machine learning algorithms to process and categorize incoming signals 118. The first learning model 210(1) may employ natural language processing (NLP) techniques to extract transaction-related information from unstructured text in messages, emails, and notifications, similar to how entity recognition systems identify monetary amounts, dates, and service names within communications. Additionally, the model 210(1) may utilize supervised learning algorithms trained on historical transaction data to classify incoming information into relevant categories such as payment updates, schedule changes, or service modifications, enabling efficient organization of transaction data within the personal knowledge base 124. The first learning model 210(1) may categorize and extract relevant information from incoming signals 118, storing structured data in the personal knowledge base 124.

The collection module 120 interfaces with various service APIs, including a notification service API 202, communication service API 204, transaction service API 206, and banking service API 208. These APIs enable the collection module 120 to gather diverse transaction data from multiple sources (e.g., multiple communication channels), including mobile application messages and notifications, messaging platform communications, financial institutions message, and payment processor signals, as some non-limiting examples of the incoming signals 118.

Connected to the collection module 120 is the personal knowledge base 124, which acts as a centralized repository for storing and organizing transaction data. The personal knowledge base 124 may be implemented as a structured database with capabilities for efficient data retrieval and update operations. Alternatively, the personal knowledge base 124 may be implemented as a knowledge graph structure that represents transactions, entities, and their relationships through interconnected nodes and edges, enabling complex query capabilities and semantic understanding of transaction contexts. Other implementations may include a document-oriented database optimized for flexible schema evolution, a time-series database specialized for chronological transaction data analysis, or a hybrid storage system that combines in-memory caching for frequently accessed transaction patterns with persistent storage for historical records. The personal knowledge base 124 maintains historical transaction information, user preferences, and patterns identified by the system.

The change detection engine 126 analyzes the data stored in the personal knowledge base 124 to identify modifications in recurring transactions. This engine incorporates a second learning model 210(2), which may utilize advanced pattern recognition and anomaly detection algorithms to discern significant changes from normal variations in transaction parameters. The second learning model 210(2) may implement gradient boosting decision trees to identify statistically significant deviations in payment amounts, recurrent neural networks (RNNs) to analyze temporal patterns in transaction frequencies, or transformer-based models to contextualize changes against historical transaction behaviors. For example, the model 210(2) is configurable to distinguish between a one-time increase in a utility bill due to seasonal variation versus a permanent price increase for a subscription service by analyzing the semantic context of accompanying communications. The change detection engine 126 regularly analyzes data, employing the second learning model 210(2) to identify potential changes in recurring transactions.

In examples, the first learning model 210(1) and the second learning model 210(2) are integrated into a single learning model 210 that is accessible to the collection model 120 and the change detection engine 126 to perform machine learning in support of each's different respective functions.

The change 212 within the change detection engine 126 is generated to flag one or more detected alterations in the personal knowledge base 124 for further processing. When the change 212 is detected, the change detection engine 126 generates a transaction update 128, for instance. The transaction update 128 encapsulates the details of the change 212, including an indication of an affected transaction, an indication of a severity or nature of the change 212, and relevant contextual information useful to obtain the consent 134. The transaction update 128 serves as a bridge between the detection of the change 212 and the subsequent actions taken by the system 200.

The interface module 130 manages the user-facing aspects of the system 200. The interface module 130 generates the alert 132, and configures an output of the alert 132 for notifying users about detected changes in recurring transactions. The alert 132 may include details about the detected change and a consent request 214, allowing the user to review and approve the proposed update. The consent request 214 element managed by the interface module 130 facilitates user interaction in the user interface 108, enabling users to review and approve or reject proposed updates to recurring transactions by providing user input 216.

The autotrans update module 136 handles the automated aspects of transaction updates. This module interfaces with scheduled transaction APIs 218, which may connect to various transaction services (e.g., APIs 202 through 209) to implement approved changes to recurring transactions. The autotrans update module 136 generates the update signals 140 that ensure user-approved updates are accurately reflected in future transactions. The system 200 adapts to various types of recurring transactions and changes, from simple modifications in payment amounts to more complex alterations in transaction schedules or recipients. The modular design of the system 200 allows for flexibility and scalability, enabling future enhancements or additions to capabilities without a complete overhaul of the architecture.

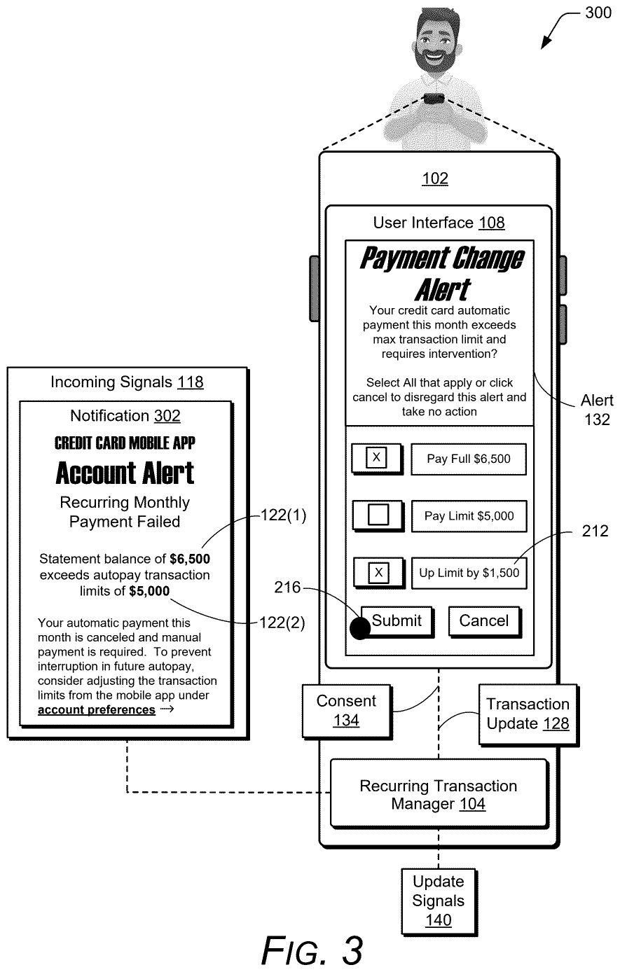

FIG. 3 illustrates an example scenario 300 involving application notifications processed into suggested updates of recurring device transactions, in accordance with one or more implementations as described herein. The scenario 300 demonstrates how the system 200 handles changes in credit card autopay situations, particularly when transaction amounts exceed predefined limits.

In the scenario 300, the computing device 102 receives incoming signals 118 including a notification 302 related to a credit card mobile app account alert. The notification 302 includes transaction data 122 indicating that a recurring monthly payment has failed because a statement balance exceeds an autopay transaction limit. Specifically, Rakesh, a frequent credit card user, had set up an autopay instruction with a maximum amount cap of $5,000 to clear monthly dues automatically. However, during a high-spending month, Rakesh's total bill reached $6,500. When the autopay attempted to clear the amount, the transaction failed due to the predefined maximum limit.

The recurring transaction manager 104 processes the information and detects the change 212 in the transaction amount. In response, the interface module 130 generates an alert 132 that is displayed on the user interface 108. The alert informs Rakesh about the payment change situation and presents options for handling the payment discrepancy, including paying the full amount, setting a new payment limit, or adjusting the limit by a specific amount.

The alert 132 may include details such as the current autopay limit ($5,000), the actual bill amount ($6,500), and the shortfall or change 212 ($1,500). The interface 108 provides submit and cancel buttons for receiving the consent 134 from Rakesh through user input 216. Based on the user input 216 and consent 134, the autotrans update module 136 generates update signals 140 to modify the payment parameters. The update signals 140 may involve requesting or commanding an increase of the autopay limit, scheduling an additional payment, or updating the recurring transaction settings to prevent future occurrences of the issue. The scenario 300 demonstrates how the system 200 can proactively detect and address potential payment failures due to preset limits, helping users like Rakesh avoid penalties and maintain timely payments for varying bill amounts.

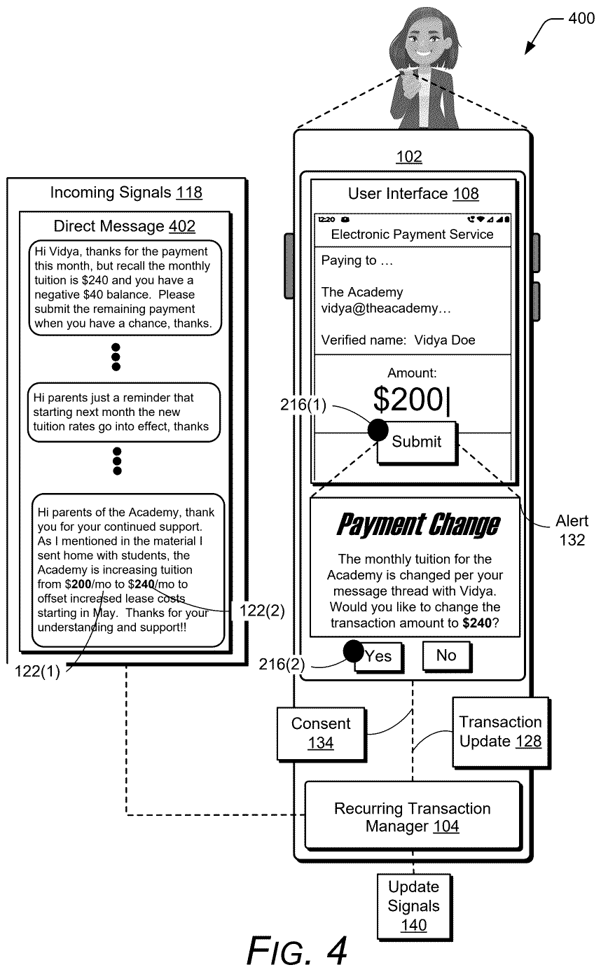

FIG. 4 illustrates an example scenario 400 involving direct messages processed into suggested updates of recurring device transactions, in accordance with one or more implementations as described herein. The scenario 400 demonstrates how the system 200 handles payment updates communicated through informal channels like messaging applications.

In the scenario 400, the computing device 102 receives incoming signals 118 that include direct messages 402 containing payment-related communications. The direct messages 402 include first transaction data 122(1) and second transaction data 122(2) related to a drawing class fee. Specifically, Vidya, a drawing teacher who runs classes for children in a housing society, has increased fees from $200 to $240 per month. Vidya informed parents of the change through the direct message 402 and personal calls.

The collection module 120 captures these communications and extracts the relevant transaction data 122, including the old fee amount ($200) as first transaction data 122(1) and the new fee amount ($240) as second transaction data 122(2). The change detection engine 126 identifies the change 212 in a recurring transaction parameter (e.g., the increase of $40).

In response, the interface module 130 generates an alert 132 that is displayed on the user interface 108 of the parents' computing devices 102. The alert 132 notifies them about the fee increase and provides options to update the recurring payment amount. The alert 132 presents details such as the current payment amount ($200), the new required amount ($250), and the effective date of the change. Users can provide a first user input 216(1) to submit the payment. The alert 132 pops up in response to the first user input 216(1) to request a second user input 216(2) to confirm or decline the suggested payment update. Upon receiving consent 134 from a user through the second user input 216(1), the autotrans update module 136 processes the transaction update 128 and generates update signals 140 to modify the recurring payment amount in the relevant payment systems or apps. The scenario 400 illustrates how the system 200 can help service providers like Vidya avoid awkward situations and time-consuming follow-ups by automatically notifying clients of payment changes and facilitating seamless updates to recurring transactions.

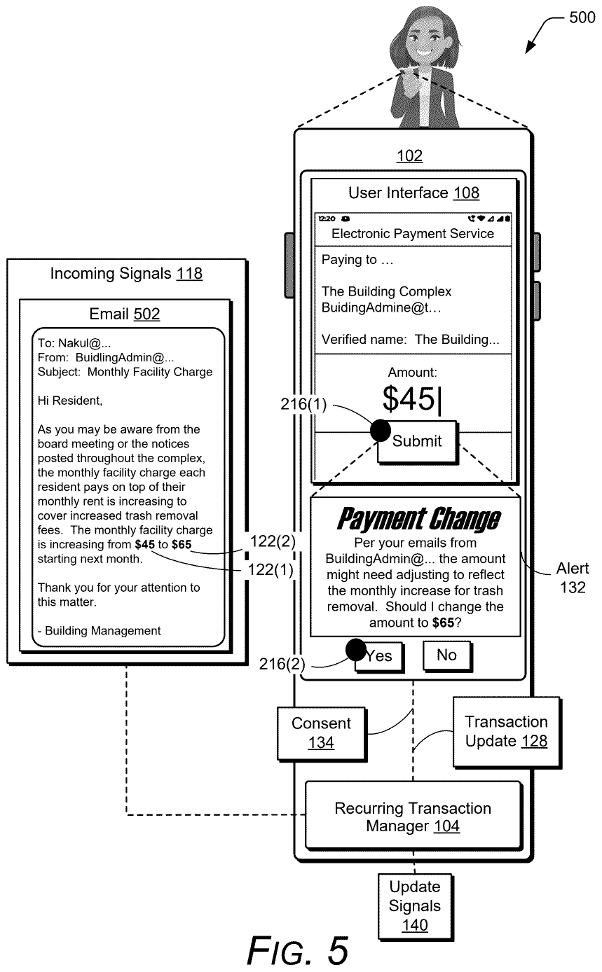

FIG. 5 illustrates an example scenario 500 involving emails processed into suggested updates of recurring device transactions, in accordance with one or more implementations as described herein. The scenario 500 demonstrates how the system 200 handles payment updates communicated through formal electronic communications such as emails.

In the scenario 500, the computing device 102 receives incoming signals 118 that include an email 502 containing information about a monthly facility charge increase from $45 to $65. The email 502 includes first transaction data 122(1) and second transaction data 122(2) related to a building maintenance fee. Specifically, the email 502 is sent from a building administrator to a resident regarding the updated payment amount for trash removal services.

The collection module 120 captures this communication and extracts the relevant transaction data 122, including the old fee amount ($45) as first transaction data 122(1) and the new fee amount ($65) as second transaction data 122(2). The change detection engine 126 identifies the change 212 in a recurring transaction parameter (e.g., the increase of $20).

In response, the interface module 130 generates an alert 132 that is displayed on the user interface 108 of the resident's computing device 102. The alert 132 notifies them about the fee increase and provides options to update the recurring payment amount.

In response, the interface module 130 generates an alert 132 that is displayed on the user interface 108 of the resident's computing device 102. The alert 132 notifies them about the fee increase and provides options to update the recurring payment amount. The alert 132 presents details such as the current payment amount ($45), the new required amount ($65), and information regarding the trash removal fees. Users can provide a first user input 216(1) to submit the payment.

The alert 132 automatically appears in response to the first user input 216(1) to request a second user input 216(2) to confirm or decline the suggested payment update. Upon receiving consent 134 from a user through the second user input 216(1), the autotrans update module 136 processes the transaction update 128 and generates update signals 140 to modify the recurring payment amount in the relevant payment systems or apps.

The scenario 500 illustrates how the system 200 can help building administrators avoid awkward situations and time-consuming follow-ups by automatically notifying residents of payment changes and facilitating seamless updates to recurring transactions, ensuring timely and accurate payments without requiring manual tracking and adjustment of payment amounts.

In another implementation of the scenario 500, the system 200 handles non-financial recurring transactions, such as automated data backup schedules. In this case, the computing device 102 receives incoming signals 118 that include an email 502 from a cloud storage provider notifying the user that their current backup schedule will be modified due to system maintenance requirements. The email 502 includes first transaction data 122(1) indicating the current weekly backup schedule and second transaction data 122(2) suggesting a change to a bi-weekly schedule with increased data volume capacity per backup.

The collection module 120 extracts this non-financial transaction data, and the change detection engine 126 identifies the change 212 in the backup frequency and data volume parameters. The interface module 130 then generates an alert 132 displayed on the user interface 108, notifying the user about the proposed changes to their automated backup schedule and requesting confirmation. The alert 132 presents details comparing the current backup parameters with the proposed changes, including potential benefits such as improved storage efficiency and reduced system resource usage.

Upon receiving consent 134 through user input 216, the autotrans update module 136 processes the transaction update 128 and generates update signals 140 to modify the automated backup schedule. This example demonstrates how the system 200 can effectively manage non-financial recurring transactions, providing users with the same level of control and convenience for their data management tasks as they have for financial transactions.

The system 200 further enhances user experience by analyzing patterns in user responses to previous alerts across different transaction types. For instance, the system may observe that a user consistently approves payment increases for certain charges but frequently rejects changes to subscription services. Based on these patterns, the interface module 130 customizes the presentation of alerts 132, such as using more prominent notifications for services or providing additional contextual information for subscription changes. Additionally, the learning models 210 are continuously adjusted based on user responses, improving the accuracy of future change detection and reducing false positives. For example, if a user frequently rejects suggested updates for certain transaction types, the system 200 refines detection thresholds for those categories, ensuring significant or highly relevant changes trigger alerts.

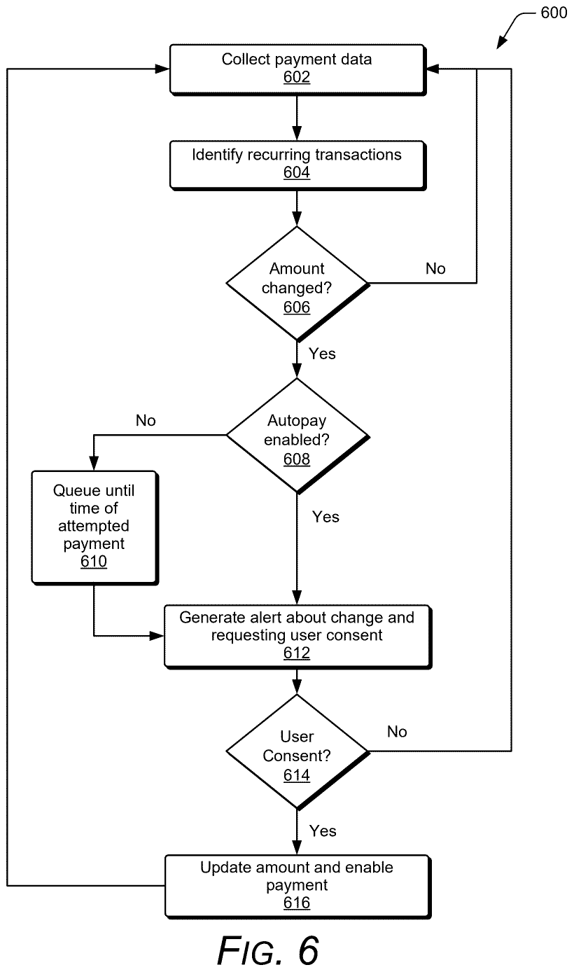

FIGS. 6, 7, 8, and 9 illustrate example processes for executing suggested updates of recurring device transactions, in accordance with one or more implementations described herein. The processes illustrated in these drawings include steps illustrated and referred to as blocks that may be executed in the order shown or in a different order, including using additional or fewer blocks and steps than those shown. The processes are combinable in various ways to implement techniques for suggested updates of recurring device transactions. Each of these processes is executable by the computing device 102 or the system 200, and is described in the context of the environment 100.

FIG. 6 is a flowchart illustrating an example process 600 for executing suggested updates of recurring device transactions, in accordance with one or more implementations as described herein. The process 600 effectively addresses scenarios like Vidya's art class fee increase, Nakul's apartment maintenance fee adjustment, and Rakesh's credit card payment limit modification, providing a comprehensive solution for managing changes in recurring transaction parameters across various use cases.

The process 600 begins at step 602 where the computing device 102 collects payment data from various sources including notifications, messages, emails, and transaction logs. This collection step gathers transaction-related information across multiple communication channels, similar to how the collection module 120 processes incoming signals 118 as described in relation to FIG. 1.

At step 604, the process 600 identifies recurring transactions by analyzing historical data and patterns to determine typical transaction parameters such as amounts, frequencies, and recipients. This identification creates transaction profiles that establish baseline expectations for future transactions.

At decision step 606, the process 600 determines whether a transaction parameter, such as a payment amount, has changed by monitoring communications for indications of modifications. If no change is detected (following the “No” path), the process 600 returns to step 602 to continue collecting payment data. If a change is detected (following the “Yes” path), the process 600 advances to decision step 608 to determine whether autopay is enabled for the affected transaction.

At step 608, the appropriate intervention strategy is selected. If autopay is not enabled (following the “No” path), the process 600 proceeds to step 610 where the transaction update is queued until the time of attempted payment, allowing for just-in-time notification when the user initiates the transaction manually. If autopay is enabled (following the “Yes” path), or after step 610, the process 600 continues to step 612 where an alert about the change is generated and user consent is requested through the user interface 108. This alert 132 presents details about the detected change and options for the user to respond.

At decision step 614, the process 600 evaluates whether user consent is received. If user consent is not received (following the “No” path), the process 600 returns to step 602 to continue monitoring. If user consent is received (following the “Yes” path), the process 600 advances to step 616 where the transaction parameter is updated and the payment is enabled with the new value. This update ensures that future recurring transactions reflect the correct parameters, preventing issues such as underpayments or service interruptions.

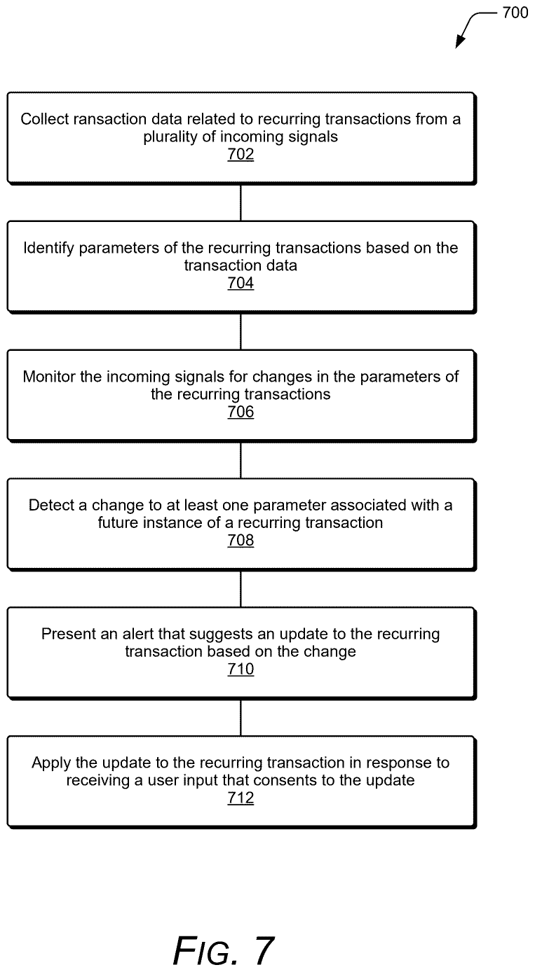

FIG. 7 is a flowchart illustrating another example process 700 for executing suggested updates of recurring device transactions, in accordance with one or more implementations as described herein. The process 700 begins at step 702, where transaction data related to recurring transactions is collected from a plurality of incoming signals. The collection module 120, for instance, gathers transaction-related information from various sources such as text messages, emails, notifications, and social media. The collection module 120 processes these incoming signals 118 to extract relevant transaction information, employing techniques such as named entity recognition to identify monetary amounts, dates, and service names within unstructured text.

The process 700 then proceeds to step 704, where parameters of the recurring transactions are identified based on the transaction data. For example, the change detection engine 126 analyzes the collected transaction data to determine transaction frequency, amounts, and recipients. The engine 126 creates transaction profiles stored within the personal knowledge base 124 according to the identified patterns.

Following step 704, the process 700 moves to step 706, where the incoming signals are monitored for changes in the parameters of the recurring transactions. The change detection engine 126 analyzes new incoming signals against existing transaction profiles stored in the personal knowledge base 124. The engine 126 employs machine learning models to identify potential changes in recurring transactions.

The process 700 then advances to step 708, where a change to at least one parameter associated with a future instance of a recurring transaction is detected. For instance, the change detection engine 126 identifies an increase in a monthly art class material fee from $30 to $50. The engine 126 distinguishes between normal fluctuations and actual changes to fixed recurring amounts.

Following step 708, the process 700 proceeds to step 710, where an alert is presented that suggests an update to the recurring transaction based on the change. The interface module 130 generates an alert 132 and displays the alert through the user interface 108. The alert includes details about the detected change and options for the user to accept or reject the change.

The process 700 concludes at step 712, where the update is applied to the recurring transaction in response to receiving a user input that consents to the update. Upon receiving user consent 134 through the user interface 108, the autotrans update module 136 processes the accepted change and generates update signals 140. These update signals are then sent to the relevant service providers to ensure future recurring transactions reflect the updated transaction parameter.

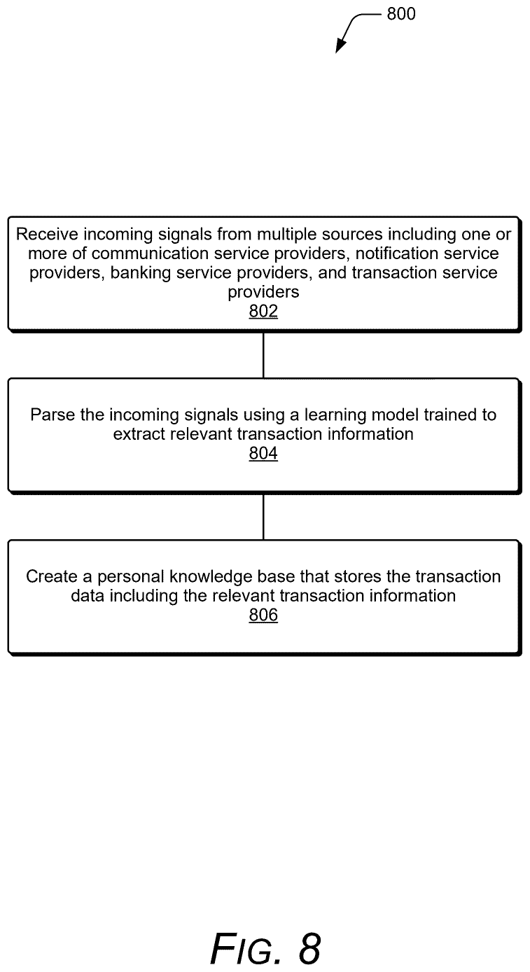

FIG. 8 illustrates a flowchart of a process 800 for executing suggested updates of recurring device transactions, in accordance with one or more implementations as described herein. The process 800 focuses on the collection and processing of incoming signals from various sources to extract transaction-related information. The process 800 is an example of the step 702 from the process 700.

The process 800 begins at step 802, where incoming signals are received from multiple sources including one or more of communication service providers, notification service providers, banking service providers, and transaction service providers. For example, the collection module 120 interfaces with various service APIs, such as the notification service API 202, communication service API 204, transaction service API 206, and banking service API 208, to gather diverse transaction data from multiple channels.

The process 800 then proceeds to step 804, where the incoming signals are parsed using a learning model trained to extract relevant transaction information. The collection module 120 employs the first learning model 210(1), which utilizes natural language processing techniques to identify and extract transaction-related data from unstructured text in messages, emails, and notifications.

The process 800 concludes at step 806, where a personal knowledge base is created that stores the transaction data including the relevant transaction information. The extracted and processed transaction data is stored in the personal knowledge base 124, which serves as a centralized repository for maintaining historical transaction information, user preferences, and identified patterns.

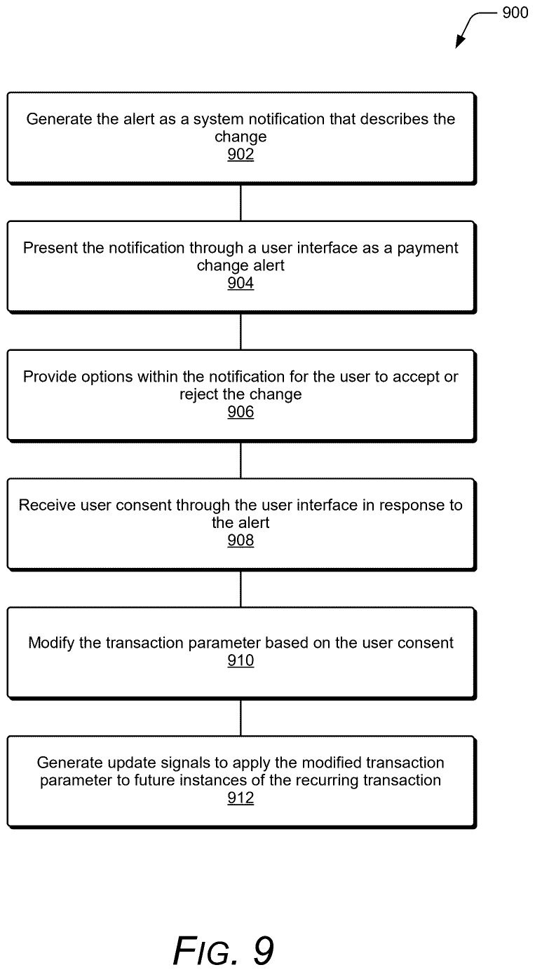

FIG. 9 illustrates a flowchart of a process 900 for executing suggested updates of recurring device transactions, in accordance with one or more implementations as described herein. The process 900 outlines the steps involved in generating and presenting alerts to users about detected changes in recurring transactions. The process 900 is an example of the steps 710 and 712 from the process 700.

The process 900 begins at step 902, where an alert is generated as a system notification that describes a change. The interface module 130 creates an alert 132 based on the transaction update 128 generated by the change detection engine 126 when a modification in a recurring transaction parameter is identified.

The process 900 then moves to step 904, where the notification is presented through a user interface as a payment change alert. The interface module 130 displays the alert 132 on the user interface 108, providing details about the detected change in the recurring transaction.

Following step 904, the process 900 proceeds to step 906, where options within the notification for the user to accept or reject the change are provided. The alert 132 includes interactive elements allowing the user to review and respond to the suggested update.

The process 900 then advances to step 908, where user consent is received through the user interface in response to the alert. The user provides input 216 through the user interface 108 to indicate their decision regarding the proposed change.

Following receipt of user consent, the process 900 moves to step 910, where the transaction parameter is modified based on the user consent. The autotrans update module 136 processes the accepted change and prepares to update the relevant transaction settings.

The process 900 concludes at step 912, where update signals are generated to apply the modified transaction parameter to future instances of the recurring transaction. The autotrans update module 136 creates update signals 140 that are sent to the appropriate service providers to implement the approved changes in future recurring transactions.

FIG. 10 illustrates various components of an example device 1000 that may be used to implement the techniques for s suggested updates of recurring device transactions in accordance with one or more implementations as described herein. The example device 1000 may be implemented as any of the devices described with reference to the previous FIGS. 1-9, such as any type of a wireless device, mobile device, mobile phone, flip phone, client device, companion device, display device, tablet, computing, communication, entertainment, gaming, media playback, and/or any other type of computing, consumer, and/or electronic device. For example, the computing device 102 and the system 200 may be implemented as the example device 1000, and includes a recurring transaction manager 1018 as an example of the recurring transaction manager 104.

The example device 1000 can include various, different communication devices 1002 that enable wired and/or wireless communication of device data 1004 with other devices. The device data 1004 can include any of the various devices data and content that is generated, processed, determined, received, stored, and/or communicated from one computing device to another. Generally, the device data 1004 can include any form of audio, video, image, graphics, and/or electronic data that is generated by applications executing on a device. The communication devices 1002 can also include transceivers for cellular phone communication and/or for any type of network data communication.

The example device 1000 can also include various, different types of data input/output (I/O) interfaces 1006, such as data network interfaces that provide connection and/or communication links between the devices, data networks, and other devices. The data I/O interfaces 1006 may be used to couple the device to any type of components, peripherals, and/or accessory devices, such as a computer input device that may be integrated with the example device 1000. The I/O interfaces 1006 may also include data input ports via which any type of data, information, media content, communications, messages, and/or inputs may be received, such as user inputs to the device, as well as any type of audio, video, image, graphics, and/or electronic data received from any content and/or data source.

The example device 1000 includes a processor system 1008 of one or more processors (e.g., any of microprocessors, controllers, and the like) and/or a processor and memory system implemented as a system-on-chip (SoC) that processes computer-executable instructions. The processor system 1008 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 1010. The example device 1000 may also include any type of a system bus or other data and command transfer system that couples the various components within the device. A system bus can include any one or combination of different bus structures and architectures, as well as control and data lines.

The example device 1000 also includes memory and/or memory devices 1012 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 1012 include volatile memory and non-volatile memory, fixed and removable media devices, and any suitable memory device or electronic data storage that maintains data for computing device access. The memory devices 1012 can include various implementations of random-access memory (RAM), read-only memory (ROM), flash memory, and other types of storage media in various memory device configurations. The example device 1000 may also include a mass storage media device.

The memory devices 1012 (e.g., as computer-readable storage memory) provide data storage mechanisms, such as to store the device data 1004, other types of information and/or electronic data, and various device applications 1014 (e.g., software applications and/or modules). For example, an operating system 1016 may be maintained as software instructions with a memory device 1012 and executed by the processor system 1008 as a software application. The device applications 1014 may also include a device manager, such as any form of a control application, software application, signal-processing and control module, code that is specific to a particular device, a hardware abstraction layer for a particular device, and so on.

In this example, the device 1000 includes the recurring transaction manager 1018 that implements various aspects of the described features and techniques described herein. The recurring transaction manager 1018 may be implemented with hardware components and/or in software as one of the device applications 1014, such as when the example device 1000 is implemented as the computing device 102 or the system 200 described with reference to FIGS. 1-9. In implementations, the recurring transaction manager 1018 may include independent processing, memory, and logic components as a computing and/or electronic device integrated with the example device 1000.

The example device 1000 can also include a microphone 1020 (e.g., to capture an audio recording) and/or camera devices 1022, as well as device sensors 1024, such as may be implemented as components of an inertial measurement unit (IMU). The device sensors 1024 may be implemented with various sensors, such as a gyroscope, an accelerometer, and/or other types of motion sensors to sense motion of the device. The device sensors 1024 can generate sensor data vectors having three-dimensional parameters (e.g., rotational vectors in x, y, and z-axis coordinates) indicating location, position, acceleration, rotational speed, and/or orientation of the device. The example device 1000 can also include one or more power sources 1026, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 1000 can also include an audio and/or video processing system 1028 that generates audio data for an audio system 1030 and/or generates display data for a display system 1032. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 1000. Alternatively, the audio system and/or the display system are external, peripheral components to the example device.

Although implementations for suggested updates of recurring device transactions have been described in language specific to features and/or methods, the appended claims are not necessarily limited to the specific features or methods described. Rather, the specific features and methods are disclosed as example implementations for suggested updates of recurring device transactions, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a computing device, including: at least one memory, and at least one processor coupled with the at least one memory and configured to cause the computing device to: collect transaction data, identify one or more recurring transactions based on the transaction data, determine whether a transaction parameter of a future recurring transaction from the one or more recurring transactions is changed, responsive to determination of a change in the transaction parameter, associate the future recurring transaction with an automatic payment, output an alert indicating the change and requesting user consent to update the transaction parameter, and update the transaction parameter prior to executing the future recurring transaction.

In some aspects, the techniques described herein relate to a computing device, wherein to collect the transaction data the at least one processor is further configured to cause the computing device to: receive incoming signals from multiple sources including one or more of communication service providers, notification service providers, banking service providers, and transaction service providers, parse the incoming signals using a learning model trained to extract relevant transaction information, and create a personal knowledge base that stores the transaction data including the relevant transaction information.

In some aspects, the techniques described herein relate to a computing device, wherein to identify the one or more recurring transactions the at least one processor is further configured to cause the computing device to: analyze the transaction data from the personal knowledge base using a learning model trained to detect patterns of transaction parameters indicating at least one of transaction frequency, transaction amounts, or transaction recipients, and create transaction profiles stored within the personal knowledge base according to the patterns.

In some aspects, the techniques described herein relate to a computing device, wherein to detect the change in the transaction parameter the at least one processor is further configured to cause the computing device to: continuously monitor incoming signals for keywords related to changes in transaction parameters using a learning model that analyzes potential changes against existing transaction profiles stored in a personal knowledge base, and detect the change based on determining a detected change applies to the future recurring transaction.

In some aspects, the techniques described herein relate to a computing device, wherein to output the alert the at least one processor is further configured to cause the computing device to: generate the alert as a system notification that describes the change, display the system notification through a user interface as a payment change alert, and provide options within the system notification for obtaining the user consent.

In some aspects, the techniques described herein relate to a computing device, wherein to update the transaction parameter the at least one processor is further configured to cause the computing device to: receive user consent through the user interface in response to the alert, and modify the transaction parameter based on the user consent prior to generating update signals to apply the transaction parameter to future instances of the one or more recurring transactions.

In some aspects, the techniques described herein relate to a computing device, wherein the one or more recurring transactions include financial recurring transactions and the transaction parameter includes a transaction amount.

In some aspects, the techniques described herein relate to a computing device, wherein the one or more recurring transactions include non-financial recurring transactions.

In some aspects, the techniques described herein relate to a computing device, wherein the at least one processor is further configured to cause the computing device to use one or more machine learning models trained to analyze the transaction data and detect the change in one or more parameters of the future recurring transaction.

In some aspects, the techniques described herein relate to a method performed by a computing device, the method including: collecting transaction data related to recurring transactions from a plurality of incoming signals, identifying parameters of the recurring transactions based on the transaction data, monitoring the plurality of incoming signals for changes in the parameters of the recurring transactions, detecting a change to at least one parameter associated with a future instance of a recurring transaction, presenting an alert that suggests an update to the recurring transaction based on the change, and applying the update to the recurring transaction in response to receiving a user input that consents to the update.

In some aspects, the techniques described herein relate to a method, wherein the plurality of incoming signals are communications received from multiple sources and include one or more of device messages, application notifications, voice messages, video messages, text messages, and emails, and the collecting includes: extracting the transaction data by parsing the communications for transaction-related information, and aggregating the transaction data by constructing a personal knowledge base of historical transaction profiles representing the transaction data.

In some aspects, the techniques described herein relate to a method, wherein the detecting includes: analyzing a notification from a credit card mobile application indicating a failed recurring payment due to exceeding an autopay transaction limit, determining an updated transaction amount based on the notification, and generating the alert to suggest increasing the autopay transaction limit to accommodate the updated transaction amount.

In some aspects, the techniques described herein relate to a method, wherein the detecting includes: identifying an increase in a payment amount for a service based on direct messages by parsing the direct messages for information about the service, and comparing the increase against historical transaction data for the service prior to updating a personal knowledge base with the change.

In some aspects, the techniques described herein relate to a method, wherein the detecting includes: parsing an email regarding a change in monthly service charges, extracting an increase in a payment amount for the monthly service charges and an effective date for the increase from the email, comparing the increase with existing recurring transaction parameters stored in a personal knowledge base, and generating the alert to indicate the increase and the effective date.

In some aspects, the techniques described herein relate to a method, wherein the recurring transaction is a non-financial transaction, and the method further includes: monitoring user communications for changes in parameters related to automated data backup schedules, detecting a change in frequency or data volume of scheduled backups, presenting the alert to suggest an update to the automated data backup schedules based on the changes, and modifying the automated data backup schedules in response to receiving user consent to the update in response to the alert.

In some aspects, the techniques described herein relate to a method, further including: analyzing patterns in user responses to previous alerts across different transaction types, customizing the alert based on the patterns and a type of recurring transaction, and adjusting machine learning models used for change detection based on user responses that improve future change detection accuracy.

In some aspects, the techniques described herein relate to a system, including: a memory that maintains a personal knowledge base including payment data related to recurring financial transactions, and a recurring payment manager configured to: collect payment data related to recurring payments from a plurality of communications received from multiple sources, monitor the plurality of communications for changes in payment amounts of the recurring payments, detect a change to a payment amount associated with a future instance of a recurring payment, present an alert that suggests an update to the recurring payment based on the change, and apply the update to the recurring payment based on user input detected that consents to the update.

In some aspects, the techniques described herein relate to a system, wherein the recurring payment manager is configured to: identify whether autopay is enabled for the recurring payment, queue the update until a time of attempted payment if autopay is not enabled, and process the update if autopay is enabled.

In some aspects, the techniques described herein relate to a system, wherein the recurring payment manager is configured to maintain a history of detected changes and user responses in the personal knowledge base.

In some aspects, the techniques described herein relate to a system, wherein the recurring payment manager is configured to: analyze patterns in user responses to previous alerts across different transaction types, customize the alert based on the patterns and a type of recurring payment, and adjust machine learning models used for change detection based on the user responses.

1. A computing device, comprising:
at least one memory; and
at least one processor coupled with the at least one memory and configured to cause the computing device to:
collect transaction data;
identify one or more recurring transactions based on the transaction data;
determine whether a transaction parameter of a future recurring transaction from the one or more recurring transactions is changed;
responsive to a determination of a change in the transaction parameter, associate the future recurring transaction with an automatic payment;
output an alert indicating the change and requesting user consent to update the transaction parameter; and
update the transaction parameter prior to executing the future recurring transaction.

2. The computing device of claim 1, wherein to collect the transaction data the at least one processor is further configured to cause the computing device to:
receive incoming signals from multiple sources including one or more of communication service providers, notification service providers, banking service providers, and transaction service providers;
parse the incoming signals using a learning model trained to extract relevant transaction information; and
create a personal knowledge base that stores the transaction data including the relevant transaction information.

3. The computing device of claim 2, wherein to identify the one or more recurring transactions the at least one processor is further configured to cause the computing device to:
analyze the transaction data from the personal knowledge base using a learning model trained to detect patterns of transaction parameters indicating at least one of transaction frequency, transaction amounts, or transaction recipients; and
create transaction profiles stored within the personal knowledge base according to the patterns.

4. The computing device of claim 1, wherein to detect the change in the transaction parameter the at least one processor is further configured to cause the computing device to:
continuously monitor incoming signals for keywords related to changes in transaction parameters using a learning model that analyzes potential changes against existing transaction profiles stored in a personal knowledge base; and
detect the change based on determining a detected change applies to the future recurring transaction.

5. The computing device of claim 1, wherein to output the alert the at least one processor is further configured to cause the computing device to:
generate the alert as a system notification that describes the change;
display the system notification through a user interface as a payment change alert; and
provide options within the system notification for obtaining the user consent.

6. The computing device of claim 5, wherein to update the transaction parameter the at least one processor is further configured to cause the computing device to:
receive user consent through the user interface in response to the alert; and
modify the transaction parameter based on the user consent prior to generating update signals to apply the transaction parameter to future instances of the one or more recurring transactions.

7. The computing device of claim 1, wherein the one or more recurring transactions include financial recurring transactions and the transaction parameter includes a transaction amount.

8. The computing device of claim 1, wherein the one or more recurring transactions include non-financial recurring transactions.

9. The computing device of claim 1, wherein the at least one processor is further configured to cause the computing device to use one or more machine learning models trained to analyze the transaction data and detect the change in one or more parameters of the future recurring transaction.

10. A method performed by a computing device, the method comprising:
collecting transaction data related to recurring transactions from a plurality of incoming signals;
identifying parameters of the recurring transactions based on the transaction data;
monitoring the plurality of incoming signals for changes in the parameters of the recurring transactions;
detecting a change to at least one parameter associated with a future instance of a recurring transaction;
presenting an alert that suggests an update to the recurring transaction based on the change; and
applying the update to the recurring transaction in response to receiving a user input that consents to the update.

11. The method of claim 10, wherein the plurality of incoming signals are communications received from multiple sources and include one or more of device messages, application notifications, voice messages, video messages, text messages, and emails, and the collecting includes:
extracting the transaction data by parsing the communications for transaction-related information; and
aggregating the transaction data by constructing a personal knowledge base of historical transaction profiles representing the transaction data.

12. The method of claim 10, wherein the detecting includes:
analyzing a notification from a credit card mobile application indicating a failed recurring payment due to exceeding an autopay transaction limit;
determining an updated transaction amount based on the notification; and
generating the alert to suggest increasing the autopay transaction limit to accommodate the updated transaction amount.

13. The method of claim 10, wherein the detecting includes:
identifying an increase in a payment amount for a service based on direct messages by parsing the direct messages for information about the service; and
comparing the increase against historical transaction data for the service prior to updating a personal knowledge base with the change.

14. The method of claim 10, wherein the detecting includes:
parsing an email regarding a change in monthly service charges;
extracting an increase in a payment amount for the monthly service charges and an effective date for the increase from the email;
comparing the increase with existing recurring transaction parameters stored in a personal knowledge base; and
generating the alert to indicate the increase and the effective date.

15. The method of claim 10, wherein the recurring transaction is a non-financial transaction, and the method further comprises:
monitoring user communications for changes in parameters related to automated data backup schedules;
detecting a change in frequency or data volume of scheduled backups;
presenting the alert to suggest an update to the automated data backup schedules based on the changes; and
modifying the automated data backup schedules in response to receiving user consent to the update in response to the alert.

16. The method of claim 10, further comprising:
analyzing patterns in user responses to previous alerts across different transaction types;
customizing the alert based on the patterns and a type of recurring transaction; and
adjusting machine learning models used for change detection based on user responses that improve future change detection accuracy.

17. A system, comprising:
a memory that maintains a personal knowledge base including payment data related to recurring financial transactions; and
a recurring payment manager configured to:
collect payment data related to recurring payments from a plurality of communications received from multiple sources;
monitor the plurality of communications for changes in payment amounts of the recurring payments;
detect a change to a payment amount associated with a future instance of a recurring payment;
present an alert that suggests an update to the recurring payment based on the change; and
apply the update to the recurring payment based on user input detected that consents to the update.

18. The system of claim 17, wherein the recurring payment manager is configured to:
identify whether autopay is enabled for the recurring payment;
queue the update until a time of attempted payment if autopay is not enabled; and
process the update if autopay is enabled.

19. The system of claim 17, wherein the recurring payment manager is configured to maintain a history of detected changes and user responses in the personal knowledge base.

20. The system of claim 17, wherein the recurring payment manager is configured to:
analyze patterns in user responses to previous alerts across different transaction types;
customize the alert based on the patterns and a type of recurring payment; and
adjust machine learning models used for change detection based on the user responses.
